(19) United States
(12) Patent Application Publication
(10) Pub. No.: US 2015/0089775 A1
(43) Pub. Date: Apr. 2, 2015

(54) Piñata Rope

(71) Applicant: Ronald Dean Baldwin, Henderson, NV (US)

(72) Inventor: Ronald Dean Baldwin, Henderson, NV (US)

(21) Appl. No.: 14/499,622

(22) Filed: Sep. 29, 2014

Related U.S. Application Data
(60) Provisional application No. 61/884,752, filed on Sep. 30, 2013.

(51) Int. Cl. A63B 67/10; F16G 11/02; F16B 45/02

(52) U.S. Cl. CPC A63B 67/10; F16B 45/02; F16G 11/025
USPC 24/302

(57) ABSTRACT

A piñata rope that quickly and efficiently suspends a piñata from a horizontal support beam. The piñata rope includes a rope, an adjustable cap, a handle, and a hook. The rope includes an adjustable stop positioned within the adjustable cap to limit the length of operative rope and to prevent the adjustable cap from disengaging the rope. The hook secures a piñata onto the rope such that manipulation of the rope affects the height of the piñata. The handle provides an ergonomic grip for the participant manipulating the rope which prevents injury from handling a bare rope.

The current application claims a priority to the U.S. Provisional Patent application Ser. No. 61/884,752 filed on Sep. 30, 2013.

### FIELD OF THE INVENTION

The present invention relates generally to an apparatus to attach a piñata quickly and efficiently. More specifically, the present invention is an apparatus for a rope which includes a hook and a cap that attaches to a piñata.

### BACKGROUND OF THE INVENTION

A piñata is a breakable container that typically holds candy, toys, or both. The piñata is generally made from papier-mâché, pottery, or cloth. The piñata is the focus of a party game where the participants use a stick, bat or similar object to hit the piñata while blindfolded until it breaks and spills the contents onto the floor or ground below. The game surrounding the piñata begins by hanging the piñata using a simple pulley system. After which the first participant, who holds the stick or bat, is blindfolded, and then spun around several times to disorient the participant. Once the first participant is disoriented, a second participant controls the height of the piñata while the first participant tries to break the piñata using the stick or bat. When the piñata is broken the participants and spectators scramble to pick up the items contained within which spilled onto the floor or ground.

The present invention seeks to improve the process of hanging a piñata from the support through the use of a hook. Once the rope is hanging over the support, the piñata is easily attached to the hook. The present invention further includes a cap which allows the second participant to comfortably adjust the height and control the piñata as well as prevents rope burn injuries to the second participant.

### BRIEF DESCRIPTION OF THE DRAWINGS

FIG. 1 is a perspective view of the present invention.

FIG. 2 is a top view of the present invention.

FIG. 3 is a side view of the present invention.

FIG. 4 is a top view of the present invention with the handle and adjustable cap removed.

FIG. 5 is a detailed view of the adjustable cap, the at least one adjustable stop, and the handle.

FIG. 6 is a side view of the adjustable cap wherein the at least one adjustable stop is positioned within.

FIG. 7 is a perspective view of the present invention where the present invention is being used to support a piñata across a horizontal support beam.

### DETAIL DESCRIPTIONS OF THE INVENTION

All illustrations of the drawings are for the purpose of describing selected versions of the present invention and are not intended to limit the scope of the present invention.

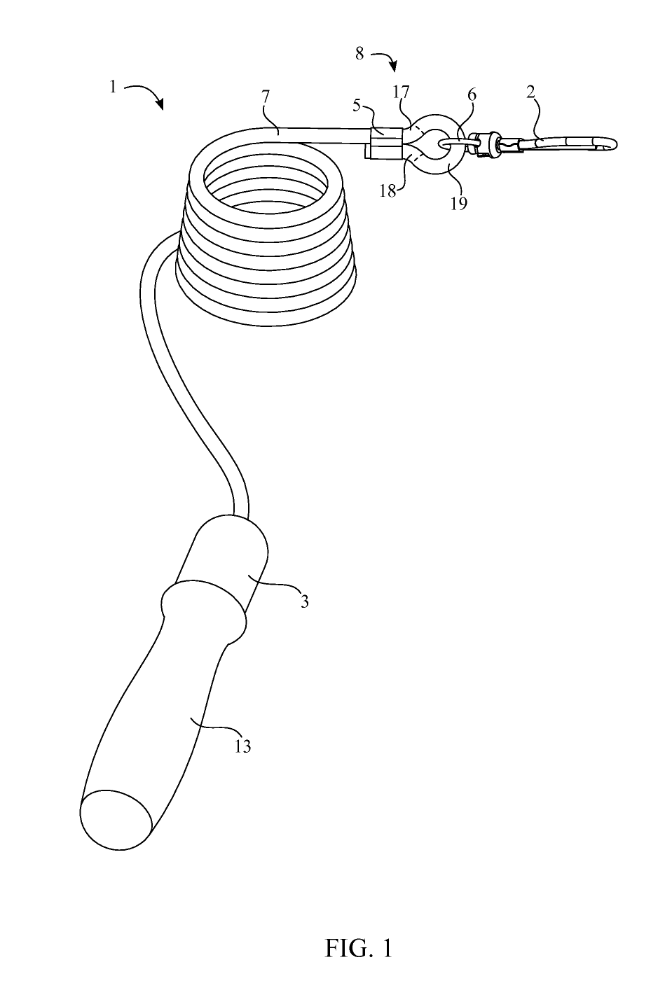

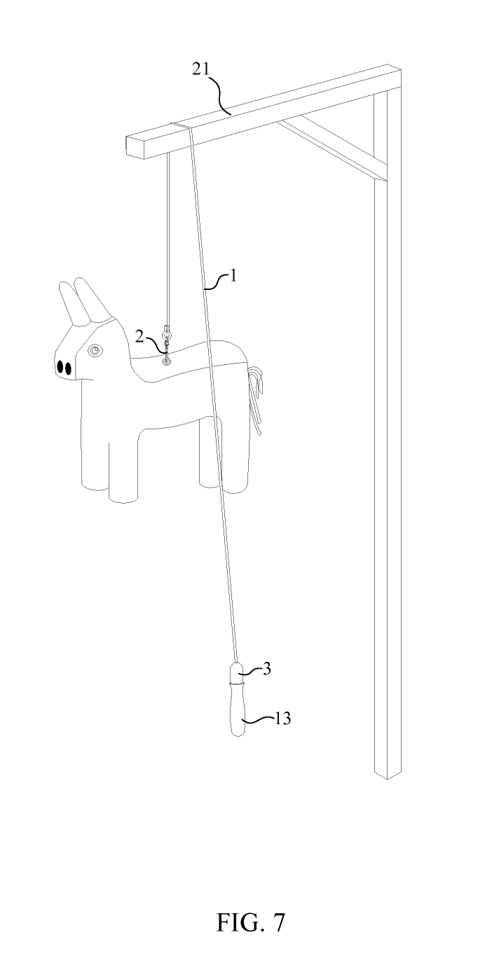

The game surrounding a piñata consists of two people: a first participant and a second participant. The first participant uses a bat, stick, or other similar object to break a piñata while blindfolded and disoriented. The second participant controls the height of the piñata to further increase of difficulty to hitting the piñata. The piñata is suspended over a horizontal support beam, such as a crossbar or a tree limb, and offset from the ground or floor, as shown in FIG. 7. The present invention seeks to improve upon the traditional means of suspension for a piñata, by providing a quick and efficient means to do so. In accordance to FIG. 1 to

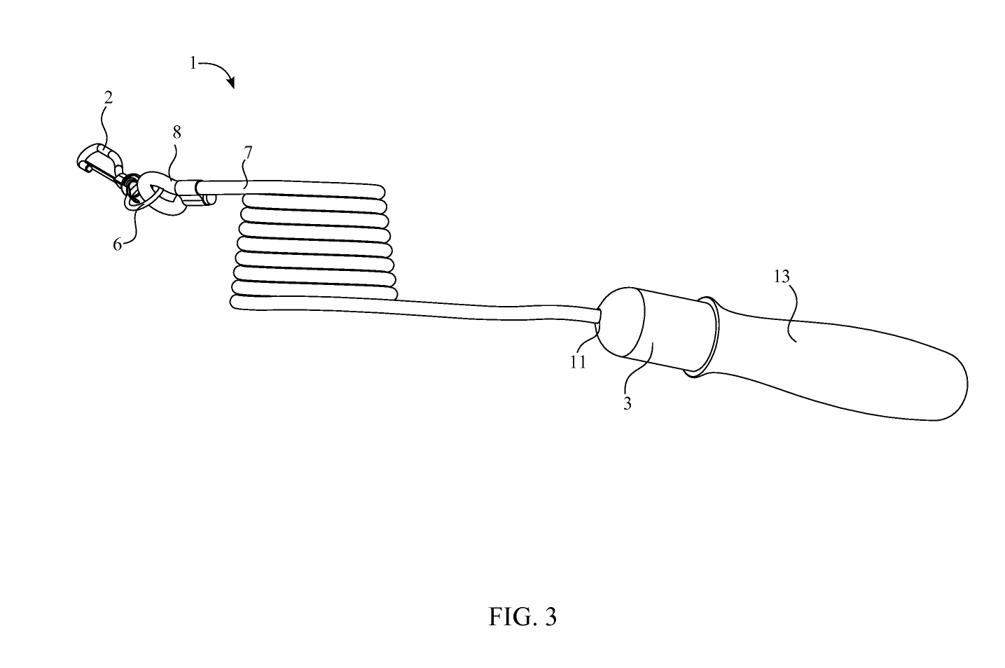

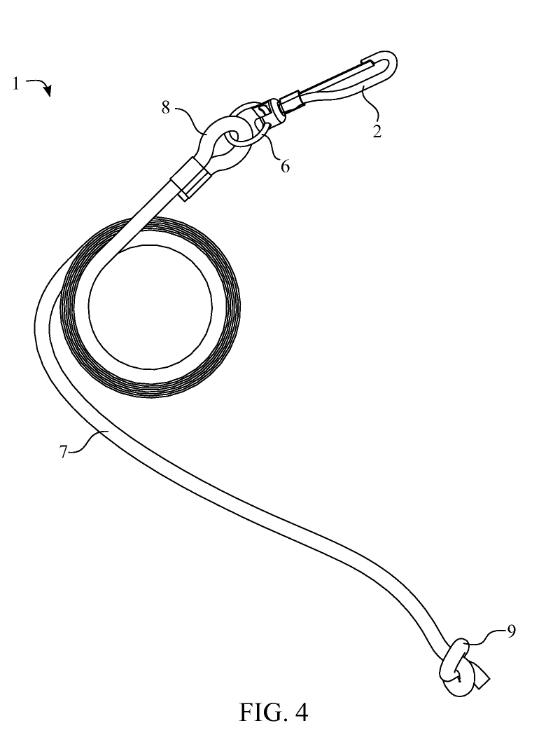

FIG. 3 and FIG. 7, the present invention comprises a rope 1, a hook 2, an adjustable cap 3, and a handle 13. The rope 1 provides tension to suspend the piñata from a support at one end of the rope 1 while the second participant controls the height from the other end. The hook 2 couples with the piñata providing direct support between the piñata and the rope 1. The hook 2 includes, but not limited to, a spring loaded clip, an eye hook, or similar hoisting attachment means to secure a load to the rope 1. The adjustable cap 3 secures the handle to the rope 1. The handle 13 provides a means for the second participant to easily control the height of the piñata. As shown in FIG. 4, the rope 1 further comprises a looped end 8 and at least one adjustable stop 9. The hook 2 is coupled to the looped end 8, securing the hook 2 to the rope 1. The at least one adjustable stop 9 is positioned along the rope 1 offset from the looped end 8 and secures the adjustable cap 3 from sliding from the rope 1.

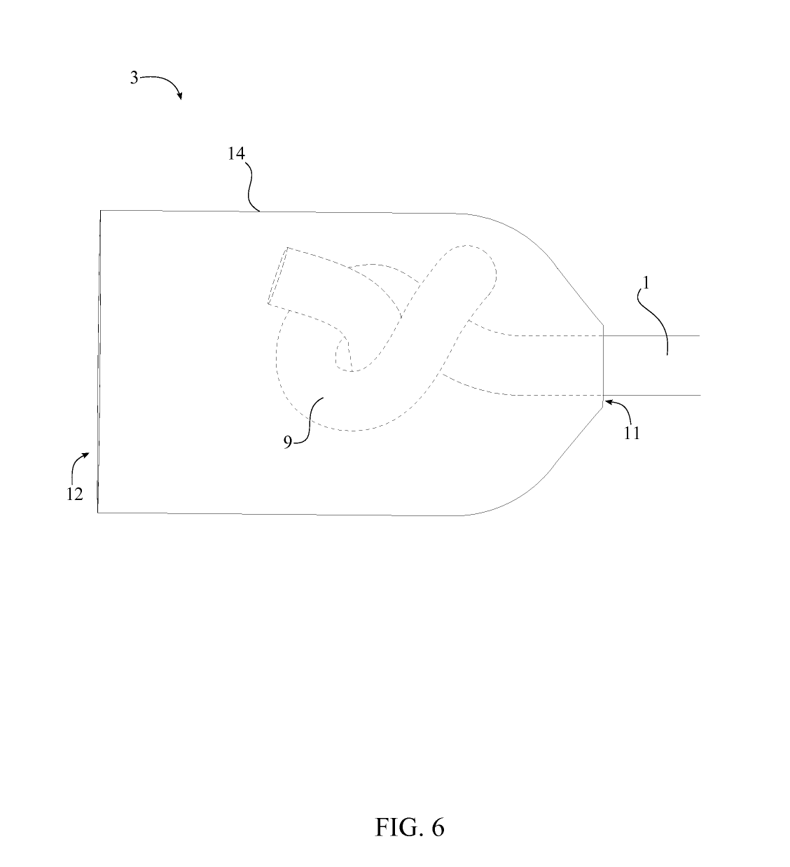

Further, the adjustable cap 3 comprises a first opening 11, a second opening 12, and a tubular portion 14, as detailed in FIG. 6. The first opening 11 is positioned opposite the second opening 12 along the tubular portion 14. The rope 1 traverses through the first opening 11 into the tubular portion 14. The tubular portion 14 is slidably positioned along the rope 1 in between the looped end 8 and the at least one adjustable stop 9. A diameter of the first opening 11 is smaller than a diameter of the second opening 12 to restrict the translation of the adjustable cap 3 in conjunction with the at least one adjustable stop 9. The at least one adjustable stop 9 is larger than the diameter of the first opening 11 such that the range which the adjustable cap 3 can slide along the rope 1 is restricted when the tubular portion 14 comes into contact with the at least one adjustable stop 9 or the looped end 8. The at least one adjustable stop 9 is positioned within the tubular portion 14, adjacent to the first opening 11. At least one adjustable stop 9 includes, but is not limited to, a knot, clasp, or similar adjustable stopping mechanisms. The handle 13 is attached to the second opening 12 to conceal and store an excess of the rope 1, while allowing the at least one adjustable stop 9 to be accessible.

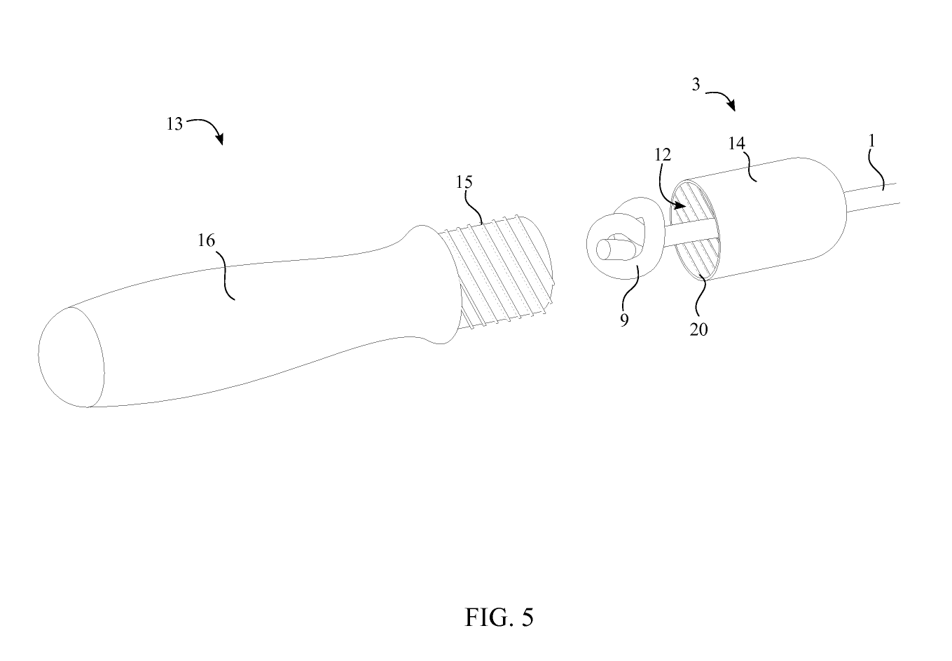

Further shown in FIG. 5, the tubular portion 14 comprises a female threading 20, and the handle 13 comprises a male threading 15 and a weighted portion 16. The female threading 20 and the male threading 15 allow for the handle 13 to be easily attached or detached from the tubular portion 14. The weighted portion 16 provides a counterweight to the weight of the piñata requiring the second participant to exert less energy to manipulate the piñata. The weighted portion 16 also provides the participants with an end that can be thrown over a horizontal support beam 21 to suspend the piñata. The male threading 15 and weighted portion 16 are positioned adjacent to each other. The female threading 20 is internally positioned within the tubular portion 14 adjacent to the second opening 12 and engaged by the male threading 15 allowing the handle 13 to be easily removed from the adjustable cap 3 such that the rope 1 may be adjusted in length.

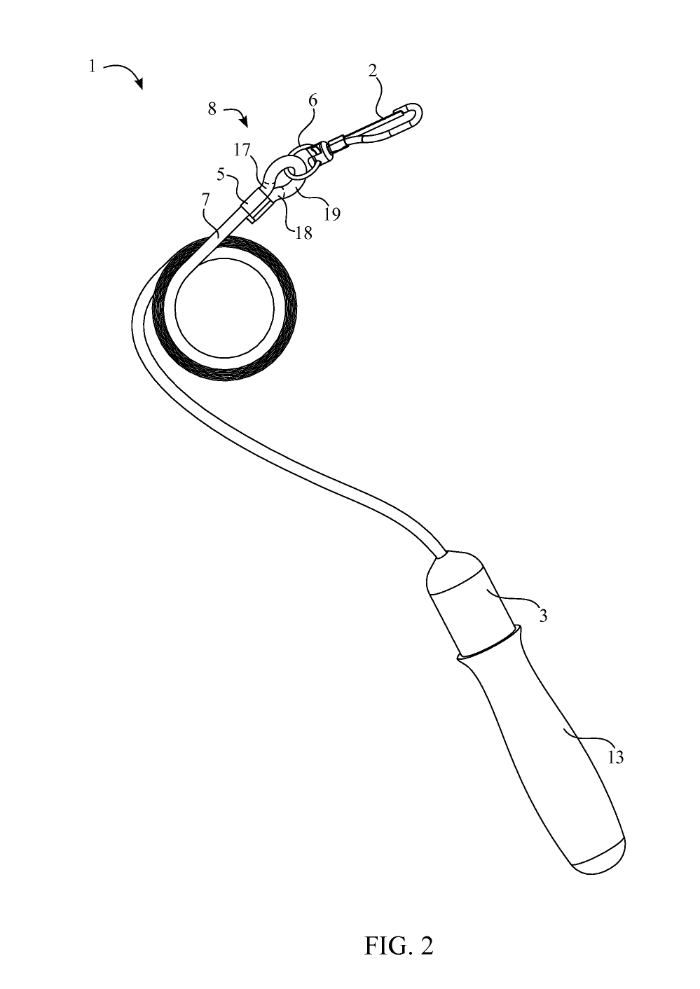

As shown in FIG. 1 to FIG. 3, the present invention further comprises a rope fastener 5 and an attachment link 6. The rope fastener 5 assists in delineated the looped end 8. The looped end 8 comprises a first fastening end 17, a second fastening end 18, and an intermediate portion 19. The intermediate portion 19 is adjacently connected to the elongated portion 7 through the first fastening end 17. The attachment link 6 is rotatably and adjacently connected to the hook 2. The looped end 8 is coupled through the attachment link 6. The second fastening end 18 is positioned opposite the first fastening end 17 along the intermediate portion 19. The first fastening end 17 adjacently attached to the second fastening end 18 by the rope fastener 5. The rope fastener 5 includes, but is not limited to, a clasp, clip, crimp, knot, compression sleeve or similar means of attachment without departing from the spirit of the present invention.

In the preferred method of use for the present invention, the participants additionally make use of a horizontal support beam 21. The horizontal support beam 21 can be manufactured or naturally occurring, such a tree branch. Once the users have a suitable horizontal support beam 21, the hook 2 is thrown over the horizontal support beam 21. The hook 2 is then lowered to a height the participants can reach. The participants attach a piñata to the hook 2 and raise it roughly to shoulder height by the second participant. The first participant is blindfolded and spun around in circles to disorient them. They are then given a blunt object such as a stick or bat to hit the piñata in attempt to break it open in order to collect the contents stored within. While the first participant is attempting to break open the piñata, the second participant raises and lowers the piñata by use of the handle 13 to increase the difficulty of hitting the piñata. If the rope 1 is too long for the given height of the horizontal support beam 21, the roped can be shortened though use of the at least one adjustable stop 9. The participants are able to remove the handle 13 from the adjustable cap 3 to access the at least one adjustable stop 9. Sliding the adjustable cap 3 away from the at least one adjustable stop 9, the at least one adjustable stop 9 can be moved closer to the looped end 8 along the rope 1.

Although the invention has been explained in relation to its preferred embodiment, it is to be understood that many other possible modifications and variations can be made without departing from the spirit and scope of the invention as hereinafter claimed.

What is claimed is:

1. A piñata rope comprises:
a rope;
a hook;
an adjustable cap;
a handle;
the rope comprises a looped end and at least one adjustable stop;
the adjustable cap comprised a first opening, a second opening, and a tubular portion;
the hook being coupled to the looped end;
the at least one adjustable stop being positioned along the rope, offset from the looped end;
the first opening being positioned opposite the second opening along the tubular portion;
the rope traversing through the first opening into the tubular portion;
the tubular portion being slidably positioned along the rope in between the looped end and the at least one adjustable stop;
the at least one adjustable stop being positioned within the tubular portion, adjacent to the first opening; and
the handle being attached onto the second opening.

2. The piñata rope as claimed in claim 1 comprises:
a rope fastener;
the rope further comprises an elongated portion;
the looped end comprises a first fastening end, a second fastening end, and an intermediate portion;
the intermediate portion being adjacently connected to the elongated portion through the first fastening end;
the second fastening end being positioned opposite to the first fastening end along the intermediate portion; and
the first fastening end being adjacently attached to the second fastening portion by the rope fastener.

3. The piñata rope as claimed in claim 1 comprises:
an attachment link;
the attachment link being rotatably and adjacently connected to the hook; and
the looped end being coupled through the attachment link.

4. The piñata rope as claimed in claim 1 comprises:
the tubular portion further comprises a female threading;
the handle comprises a male threading and a weighted portion;
the male threading and the weighted portion being positioned adjacent to each other;
the female threading being internally positioned within tubular portion adjacent to the second opening; and
the female threading being engaged by the male threading.

5. The piñata rope as claimed in claim 1, wherein the hook is a spring-loaded clip.

6. The piñata rope as claimed in claim 1, wherein the rope fastener is a compression sleeve.

7. The piñata rope as claimed in claim 1, wherein the at least one adjustable stop is a knot.

8. The piñata rope as claimed in claim 1, a diameter of the first opening is smaller than a diameter of the second opening.

9. A piñata rope comprises:
a rope;
a hook;
an adjustable cap;
a handle;
an attachment link;
the rope comprises a looped end and at least one adjustable stop;
the adjustable cap comprised a first opening, a second opening, and a tubular portion;
the hook being coupled to the looped end;
the at least one adjustable stop being positioned along the rope, offset from the looped end;
the first opening being positioned opposite the second opening along the tubular portion;
the rope traversing through the first opening into the tubular portion;
the tubular portion being slidably positioned along the rope in between the looped end and the at least one adjustable stop;
the at least one adjustable stop being positioned within the tubular portion, adjacent to the first opening;
the handle being attached onto the second opening;
the attachment link being rotatably and adjacently connected to the hook; and
the looped end being coupled through the attachment link.

10. The piñata rope as claimed in claim 1 comprises:
a rope fastener;
the rope further comprises an elongated portion;
the looped end comprises a first fastening end, a second fastening end, and an intermediate portion;
the intermediate portion being adjacently connected to the elongated portion through the first fastening end;
the second fastening end being positioned opposite to the first fastening end along the intermediate portion; and
the first fastening end being adjacently attached to the second fastening portion by the rope fastener.

11. The piñata rope as claimed in claim 1 comprises:
the tubular portion further comprises a female threading;
the handle comprises a male threading and a weighted portion;
the male threading and the weighted portion being positioned adjacent to each other;
the female threading being internally positioned within tubular portion adjacent to the second opening; and
the female threading being engaged by the male threading.

12. The piñata rope as claimed in claim 1, wherein the hook is a spring-loaded clip.

13. The piñata rope as claimed in claim 1, wherein the rope fastener is a compression sleeve.

14. The piñata rope as claimed in claim 1, wherein the at least one adjustable stop is a knot.

15. The piñata rope as claimed in claim 1, a diameter of the first opening is smaller than a diameter of the second opening.
